(19) United States
(12) Patent Application Publication
(10) Pub. No.: US 2010/0251248 A1
(43) Pub. Date: Sep. 30, 2010

(54) JOB PROCESSING METHOD, COMPUTER-READABLE RECORDING MEDIUM HAVING STORED JOB PROCESSING PROGRAM AND JOB PROCESSING SYSTEM

(75) Inventors: Masaaki HOSOUCHI, Zama (JP); Tetsufumi Tsukamoto, Nagareyama (JP); Hideaki Abe, Yokohama (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/627,712

(22) Filed: Nov. 30, 2009

(30) Foreign Application Priority Data
Mar. 27, 2009 (JP) 2009-078339

(51) Int. Cl. G06F 9/46

(52) U.S. Cl. 718/102

(57) ABSTRACT

For data obtaining target at execution of a new task, if a data set as a processing target is beforehand allocated to a data allocation area in an allocation-target execution server as a target of allocation, a schedule server of a job processing system sets the data set as the data obtaining target; if the data set as the processing target is not beforehand allocated to the data allocation area in any one of the execution servers, the schedule server sets the data in the external storage area as the data obtaining target; and if the data set as the processing target is beforehand allocated to the data allocation area in a second execution server other than the allocation-target execution server, the schedule server sets the data set allocated to the second execution server as the data obtaining target.

### INCORPORATION BY REFERENCE

The present application claims priority from Japanese application JP2009-078339 filed on Mar. 27, 2009, the content of which is hereby incorporated by reference into this application.

### BACKGROUND OF THE INVENTION

The present invention relates to a technique for a job processing method, a computer-readable recording medium having stored a job processing program, and a job processing system.

For a system including a plurality of computers, various methods of scheduling batch jobs have been proposed to execute batch processing with a predetermined amount of collected data at a time.

JP-A-2007-272653 describes a method of scheduling for a parametric job. A parametric job is a job which is repeatedly executed by changing parameters with its job definition kept unchanged.

According to the conventional job schedule method for a parametric job, a computer to execute a task, which is one of jobs to be executed by changing parameters in the parametric job, is selected on the basis of a state of load imposed on the computer, a predicted execution time of the job, and predicted quantity of power or resources to be consumed for the task.

### SUMMARY OF THE INVENTION

The job execution time is remarkably affected by, in addition to performance of the Central Processing Unit (CPU), a wait time required for communication and input/output operations. Frequency of occurrence of communication and input/output operations depends on a location of data to be accessed by the program executed in the job.

However, since the conventional job scheduling method does not include a job schedule based on the data location, there possibly occurs a period of undesirable processing time due to the wait time for data transfer and input/output operations. In the job schedule, consideration has not been given to optimization of performance for the system re-start after computer failure or an abnormal termination of the task.

It is therefore an object of the present invention, which has been devised to remove the problems, to suppress, in execution of a task of a parametric job, the reduction in performance which depends on the location of data as a processing target of the task.

To achieve the object according to the present invention, there is provided a job processing method for use with a job processing system comprising execution servers to execute tasks of a parametric job and a schedule server which extracts each of the tasks from the parametric job and which requests associated one of the execution servers to execute the task.

The schedule server comprises a scheduler and a data allocation control table, each of the execution servers comprises a data allocation area, a data processing section, a data allocation section, and an external storage.

The data allocation section reads a data set as a processing target of the task in the data allocation area of an own execution server, and notifies correspondence information between the data set and the own execution server.

The scheduler stores, in the data allocation control table, the notified correspondence information between the data set and the own execution server to which information of a task executing the data set as a processing target is further added.

The scheduler retrieves, when selecting the execution server which can execute the task as the allocation-target execution server as an allocation target and allocating the task thereto, the data set as the processing target of the new task from the data allocation control table; for data obtaining target at execution of the allocation-target execution server in the data processing section, if the data set as the processing target is beforehand allocated to the data allocation area in the allocation-target execution server, the scheduler sets the data set as the data obtaining target; and if the data set as the processing target is beforehand allocated to the data allocation area in a second execution server other than the allocation-target execution server, the scheduler sets the data set allocated to the second execution server as the data obtaining target.

The other means will be described later.

According to the present invention, it is possible, in execution of a task of a parametric job, to suppress reduction in performance which depends on the location of data as a processing target of the task.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a job processing system according to an embodiment of the present invention;

FIG. 2 is a schematic diagram showing an example of a state of data before execution of a task (after initialization), the data being handled by a schedule server according to an embodiment of the present invention;

FIG. 3 is a schematic block diagram to explain an example of task allocation in a job processing system corresponding to the state of data before execution of a task (after initialization) shown in FIG. 2;

FIG. 4 is a schematic diagram showing an example of a state of data during execution of a task, the data being handled by a schedule server according to an embodiment of the present invention;

FIG. 5 is a schematic block diagram to explain an example of task allocation in a job processing system corresponding to the state of data during execution of a task shown in FIG. 4;

FIG. 6 is a schematic diagram showing an example of a state of data during re-execution of a task, the data being handled by a schedule server according to an embodiment of the present invention;

FIG. 7 is a schematic block diagram to explain an example of task allocation in a job processing system corresponding to the state of data during re-execution of a task shown in FIG. 6;

FIG. 8A is a flowchart showing main processing of a task schedule to be executed by a scheduler according to an embodiment of the present invention;

FIG. 8B is a flowchart showing task schedule initialization processing to be executed by a scheduler according to an embodiment of the present invention;

FIG. 9 is a flowchart showing data selection and task execution request processing to be executed by a scheduler according to an embodiment of the present invention;

FIG. 10 is a flowchart showing task execution monitor processing to be executed by a scheduler according to an embodiment of the present invention;

FIG. 11A is a flowchart showing task execution processing to be executed by a task control section according to an embodiment of the present invention; and

FIG. 11B is a flowchart showing task execution processing to be executed by a task control section according to an embodiment of the present invention.

### DESCRIPTION OF THE EMBODIMENTS

Referring now to the drawings, description will be given in detail of an embodiment of the present invention.

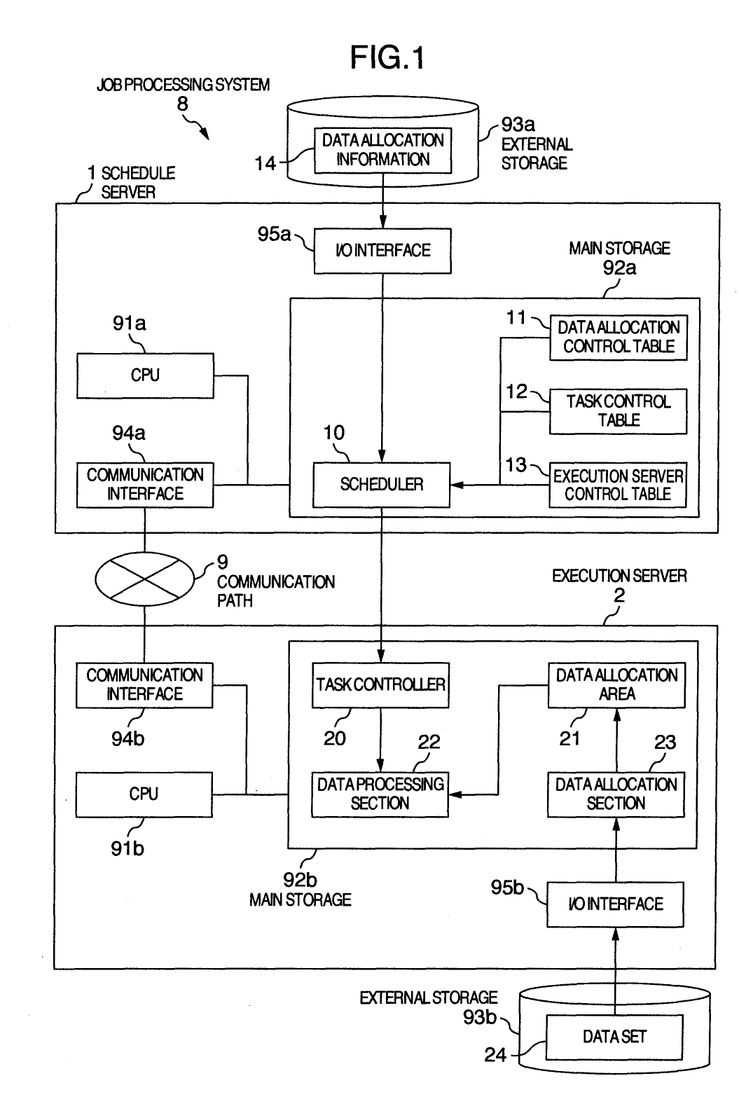

FIG. 1 shows a configuration of a job processing system 8. The job processing system 8 includes a schedule server 1 to divide a parametric job into tasks, at least one execution server 2 to execute a task allocated thereto by the schedule server 1, and a communication path 9 to link the schedule server 1 with the execution server 2. A task is the unit of operation to execute the parametric job.

The schedule server 1 includes a computer in a hardware configuration including a CPU 91a, a main storage 92a, a communication interface 94a, and an input/output interface 95a. The schedule server 1 is coupled with an external storage 93a.

The execution server 2 includes a computer in a hardware configuration including a CPU 91b, a main storage 92b, a communication interface 94b, and an input/output interface 95b. The execution server 2 is coupled with an external storage 93b.

The CPUs 91a and 91b read programs respectively from the main storages 92a and 92b to execute the programs.

The main storages 92a and 92b store programs constituting respective processing sections and data items to be processed by the processing sections.

It is also possible that the programs and the data items are stored in a nonvolatile storage, not shown, such as a Hard Disk Drive (HDD), a semiconductor memory, an optical disk and are read therefrom according to necessity. The programs and the data items may be downloaded via a communication path from an external server.

The external storages 93a and 93b store data times to be processed by associated processing sections.

The communication interfaces 94a and 94b are network interfaces which connect to the communication path 9 to relay communication with a communication party.

The input/output interfaces 95a and 95b are local interfaces to carry out data access operations of the external storages 93a and 93b.

The schedule server 1 includes a scheduler 10, a data allocation control table 11, a task control table 12, and an execution server control table 13 and is capable of accessing data allocation information 14.

The execution server 2 includes a task control section 20, a data allocation area 21, a data processing section 22, and a data allocating section 23 and is capable of accessing data set 24.

When the data allocation information 14 is received, the scheduler 10 schedules allocation of a task to an execution server 2 on the basis of the information 14.

For each data, according to the data allocation information 14, the data allocation control table 11 stores information indicating an execution server 2 to which the data is allocated and a task handling the data.

For each task, the task control table 12 stores information regarding allocation of the task.

The execution server control table 13 stores an operation status of each execution server 2, the status being data to be referred to when an execution server 2 to which a task can be allocated is selected.

The data allocation information 14 is stored in the external storage 93a. The information 14 stores information of a correspondence between data of the data set 24 allocated to the data allocation area 21 and an execution server 2 to which the data allocating section 23 belongs.

The scheduler 10 refers to the data allocation control table 11 to allocate each task to an associated execution server 2 according to priority levels (1) to (4), which will be described below, to minimize data transfers between the execution servers 2. That is, the time required for the transfer wait and the input/output wait is reduced through optimization of the schedule by referring to the data allocation state, and the CPU utilization rate is improved. Therefore, the CPU utilization rate is equal to or more than that of the schedule implemented on the basis of the CPU load. Hence, the processing time is reduced according to the reduction in time required for the transfer wait and the input/output wait.

(1) Allocation data to own computer: Data set 24 beforehand allocated to the data allocation area 21 of the allocation target execution server 2 (own computer). When the data is used, there does not occur a chance of communication (data copy processing) with any other apparatus. It is hence possible to suppress deterioration in performance.

(2) Data of failed server: Data set 24 beforehand allocated to the data allocation area 21 of the allocation target execution server 2. Unlike the situation of (1) in which each data indicated by the data ID has been allocated, each data of the data ID has not been allocated in the situation of (2). The data is temporary allocation data for which the location is indefinite, for example, data obtained by copying data of the failed server. By using the data, it is possible to reduce communication (data copy processing) with any other apparatus to some extent. The performance deterioration is also suppressed although less efficient as compared with the situation of (1).

(3) Non-allocation data: Data set 24 allocated neither to the allocation target execution server 2 (own computer) nor to any other execution server 2 (another computer). When the data is employed, the data processing section 22 reads the data set 24 via the input/output interface 95b from the external storage 93b. Hence, there does not occur a chance of communication (data copy processing) with any other apparatus, and it is hence possible to suppress deterioration in performance.

(4) Allocation data of second computer: Data set 24 beforehand allocated to the data allocation area 21 of an execution server 2 (a second computer) other than the allocation target execution server 2. When the data is employed, there occurs communication (data copy processing) from the data allocation area 21 of the second computer to the data allocation area 21 of the own computer. Hence, performance is deteriorated to some extent.

When a task allocation indication of a task is received from the scheduler 10, the task controller 20 instructs the data processing section 22 to execute the task.

The data allocation area 21 is a storage area to which the data set 24 is allocated.

The data processing section 22 reads from the data allocation area 21 the data set 24 as data to be processed by the allocated task and then executes the allocated task. In this connection, the data processing section 22 may keep the processed data set 24 remained in the data allocation area 21 or may delete the data set 24 from the area 21.

The data allocating section 23 allocates to the data allocation area 21 the data set 24 to be processed by the task which is executed by the data processing section 22. The data allocation section 23 notifies the allocation result of the data set 24 as the data allocation information 14 to the schedule server 1. The schedule server 1 may store the received data allocation information 14 in the external storage 93a or may directly notify the information 14 to the scheduler 10.

The data set 24 is stored in the external storage 93b and includes data which can be divided into a fixed number of records or a number of fixed-byte data items. Among a plurality of tasks constituting a parametric job, the data processing to execute the tasks are shared, but the data set 24 as the processing target of the data processing section 2 varies.

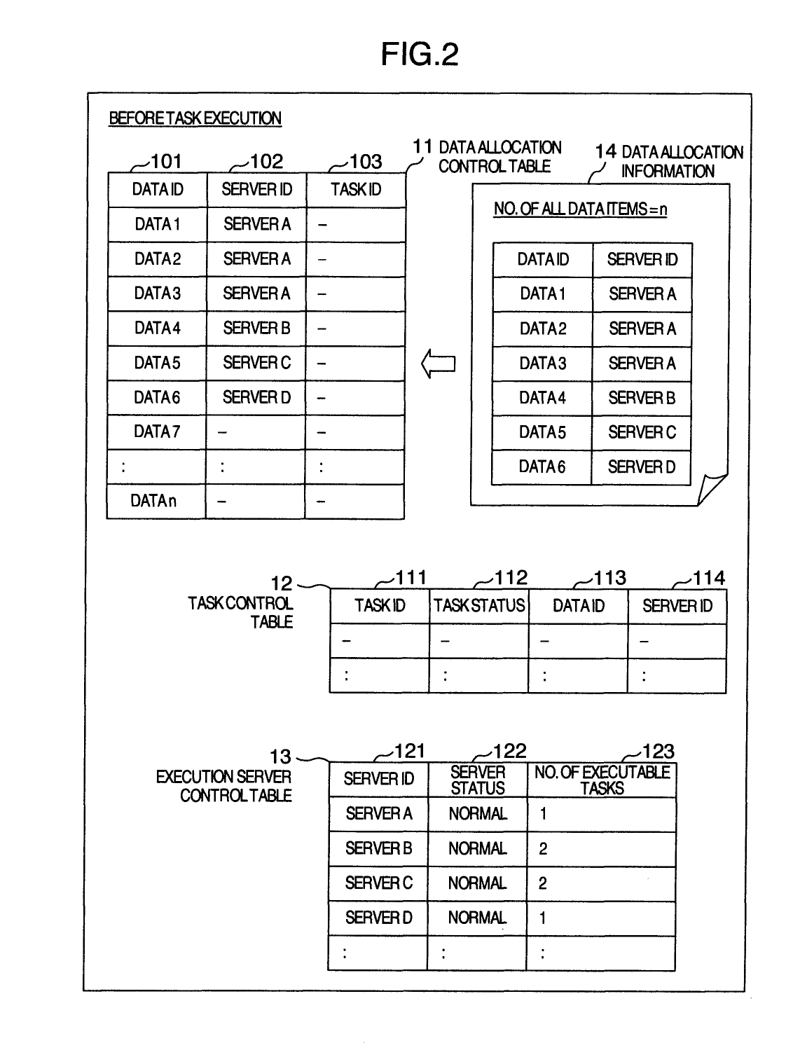

FIG. 2 shows an example of a layout of data items to be handled by the schedule server 1 before execution of a task (after initialization).

The data allocation control table 11 stores a data ID 101, a server ID 102, and a task ID 103 with a correspondence established therebetween.

The data ID 101 is an identifier (ID) of each data of the data set 24.

The server ID 102 is an ID of an execution server 2 including the data allocation area 21 as a destination of allocation of data indicated by the data ID 101. If the server ID field 102 is empty “-”, it is indicated that there exists no destination of allocation for the data indicated by the data ID 101.

The task ID 103 is an ID of a task which processes data indicated by the data ID 101. If the task ID field 103 is empty “-”, it is indicated that there exists no task to process data indicated by the data ID 101.

In the state before execution of a task shown in FIG. 2, the scheduler 10 writes in the data allocation control table 11 a set of data items, i.e., a data ID and a server ID contained in the data allocation information 14, which will be described later.

The task control table 12 stores a task ID 111, a task status 112, a data ID 113, and a server ID 114 with a correspondence established therebetween.

The task ID 111 is an ID of a task being executed or having been executed.

The task status 112 is a status of a task indicated by the task ID 111. The task status 112 is set to values of, for example, during execution, normal termination, abnormal termination, or interruption (due to failure of the execution server 2).

The data ID 113 is an ID of data as a processing target of a task indicated by the task ID 111.

The server ID 114 is an ID of an execution server 2 which executes a task indicated by the task ID 111.

In the status before execution of a task shown in FIG. 2, since no task is being processed, no entry exists for the task control table 12.

The execution server control table 13 stores a server ID 121, a server status 122, and a number of executable tasks 123 with a correspondence established therebetween.

The server ID 121 is an ID of an execution server 2.

The server status 122 is a status of an execution server 2 indicated by the server ID 121. The server status 122 is set to a value of, for example, “normal”, “failure”, or “execution request inhibition”.

The number of executable tasks 123 is an upper-limit value of the number of tasks which can be simultaneously executed at this point of time by the execution server 2 indicated by the server ID 121.

In the status before execution of a task shown in FIG. 2, the schedule server 1 collects static information (such as information collected from setting files) and dynamic information (such as a result of execution of a bench mark program and information of a task manager of an Operating System (OS)) of each execution server 2 and sets the collected information to the execution server control table 13.

The data allocation information 14 stores the number of all data items, and information of a correspondence between a data ID and a server ID.

“Number of all data items=n” indicates a value to be used to divide the data set 24 into data subsets.

The data ID is an ID of each data of the data set 24.

The server ID is an ID of an execution server 2 including the data allocation area 21 as a destination of allocation of data indicated by the data ID. If the server ID field is empty “-”, it is indicated that there exists no destination of allocation for the data indicated by the data ID.

However, if the data ID field contains a numeric value, the data ID can be inferred from the number of all data items n. Hence, for data not existing in the data allocation area 21 of any execution server 2, the data ID is not required to be described in the data allocation information 14.

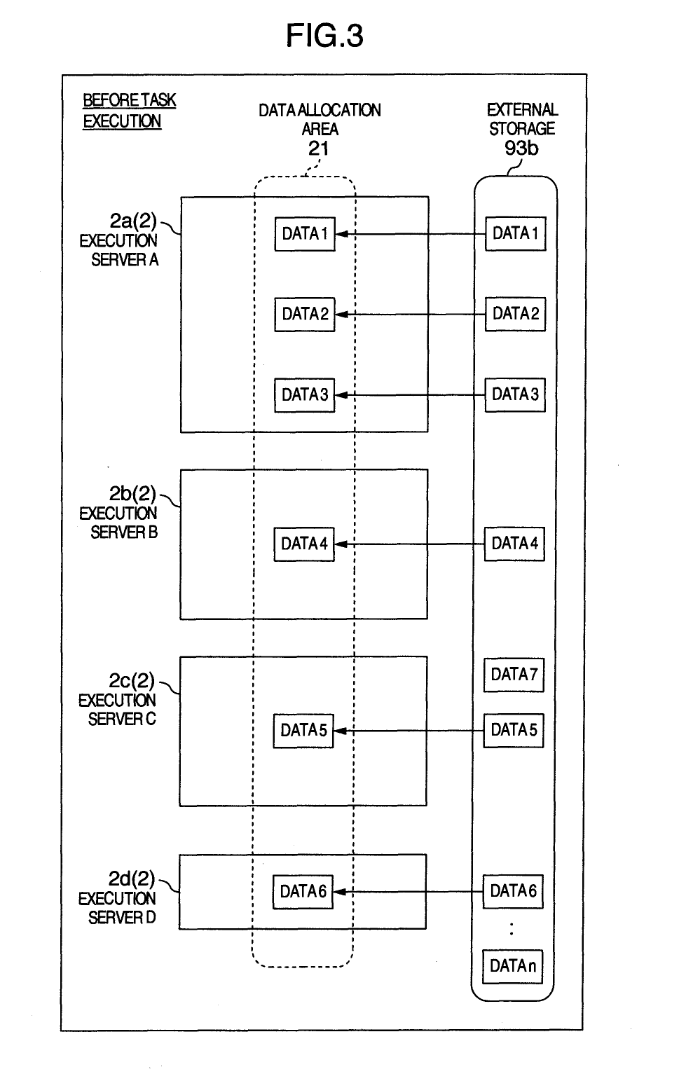

FIG. 3 shows an example of task allocation in the job processing system 8 in the status before execution of a task (after initialization) shown in FIG. 3.

Assume that the execution server 2a has a server ID of “server A”, the execution server 2b has a server ID of “server B”, the execution server 2c has a server ID of “server C”, and the execution server 2d has a server ID of “server D”.

In FIGS. 2 and 3, the data allocating section 23 reads each data set 24 (data 1 to data 6) from the external storage 93b to load the data set 24 in the data allocation area 21. Also, the data allocating section 23 writes the allocation information of data allocated by the read processing in the data allocation information 14 (FIG. 2).

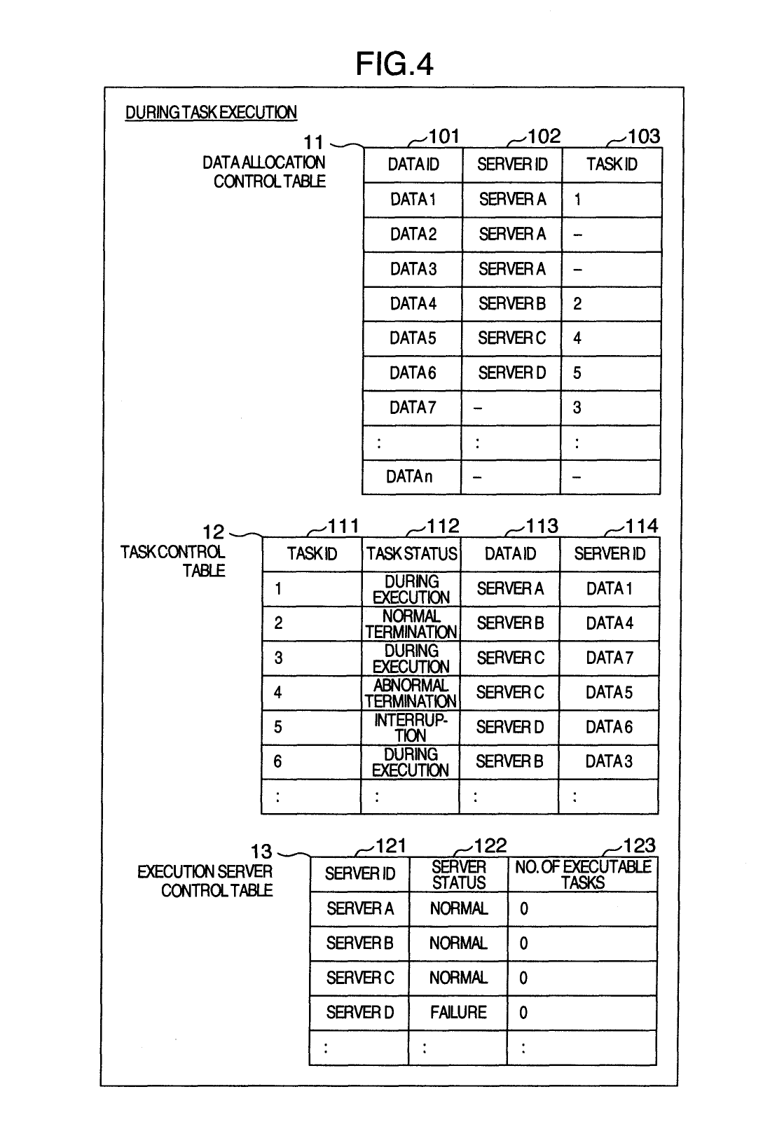

FIG. 4 shows an example of a state of data handled by a schedule server 1 during execution of a task. The state of FIG. 4 appears when a certain period of time lapses after the system enters the state of FIG. 2.

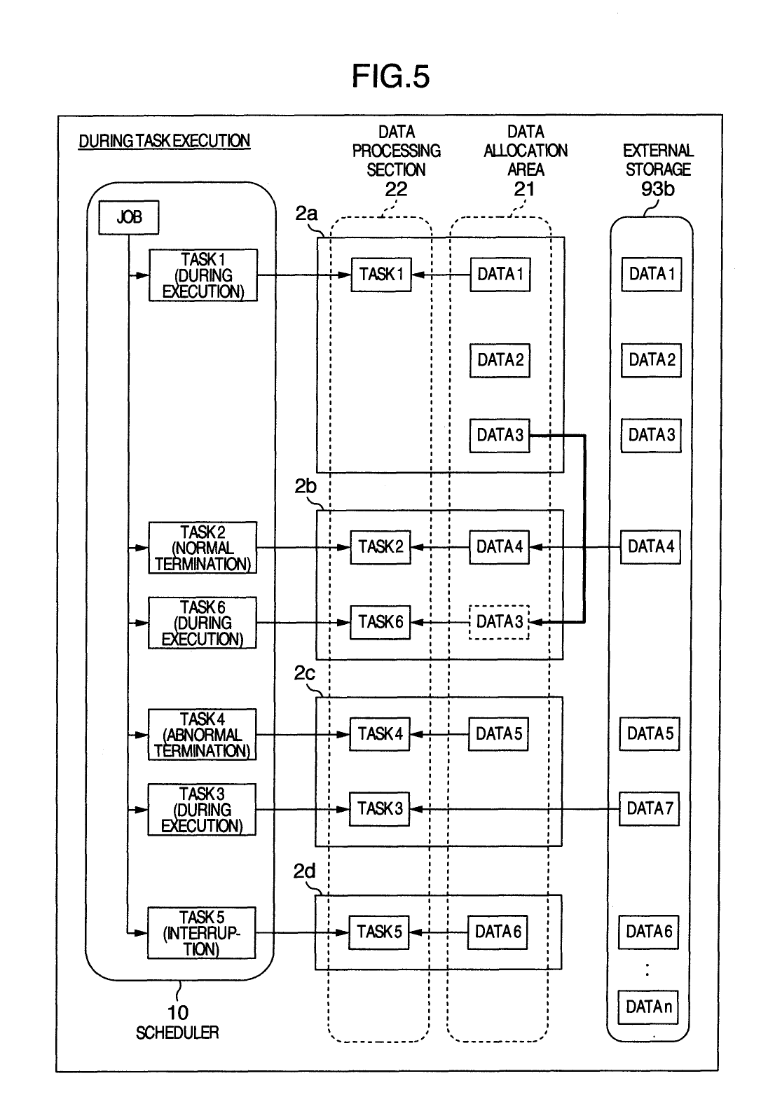

FIG. 5 shows an example of task allocation in the job processing system 8, which corresponds to the state during execution of a task shown in FIG. 4. “Data 3” in the execution server 2b is “(4) Allocation data of other computer”, namely, provisionally allocated data copied from the execution server 2a and hence is shown in a broken-line frame in FIG. 5.

First, the scheduler 10 allocates a task by setting server A as its own computer.

In allocation of the first task, i.e., task 1 to be allocated to the server A, data 1 which is “(1) allocation data to the own computer” is set as an execution target. A result of the task allocation is written in a record of “data ID 101”=“data 1” and a record of “task ID 111”=“task 1”.

In this situation, the number of executable tasks 123 of server A is one (FIG. 2). After one task is allocated as above, the number of executable tasks 123 of server A is updated to zero (FIG. 4).

Next, the scheduler 10 allocates a task by setting server B as its own computer.

In allocation of the first task, i.e., task 2 to be allocated to the server B, data 4 which is “(1) allocation data to the own computer” is set as an execution target. A result of the task allocation is written in a record of “data ID 101”=“data 4” and a record of “task ID 111”=“task 2”.

In allocation of the second task, i.e., task 6 to be allocated to the server B, data 3 which is “(4) Allocation data of other computer” is set as an execution target. A result of the task allocation is written in a record of “task ID 111”=“task 6”. In this way, when “(3) Non-allocation data” or “(4) Allocation data of other computer” is employed, the result is reflected in the task control table 12, but is not reflected in the data allocation control table 11.

In this case, the number of executable tasks 123 of server B is two (FIG. 2). After two tasks are allocated as above, the number of executable tasks 123 of server B is updated to zero (FIG. 4).

The scheduler 10 then allocates a task by setting server C as its own computer.

In allocation of the first task, i.e., task 4 to be allocated to the server C, data 5 which is “(1) allocation data to the own computer” is set as an execution target. A result of the task allocation is written in a record of “data ID 101”=“data 5” and a record of “task ID 111”=“task 4”.

In allocation of the second task, i.e., task 3 to be allocated to the server C, data 7 which is “(3) Non-allocation data” computer” is set as an execution target. A result of the task allocation is written in a record of “data ID 101”=“data 7” and a record of “task ID 111”=“task 3”.

In this situation, the number of executable tasks 123 of server C is two (FIG. 2). After two tasks are allocated as above, the number of executable tasks 123 of server C is updated to zero (FIG. 4).

Additionally, the scheduler 10 allocates a task by setting server D as its own computer.

In allocation of the first task, i.e., task 5 to be allocated to the server D, data 6 which is “(1) allocation data to the own computer” is set as an execution target. A result of the task allocation is written in a record of “data ID 101”=“data 6” and a record of “task ID 111”=“task 5”.

In this situation, the number of executable tasks 123 of server D is one (FIG. 2). After one task is allocated as above, the number of executable tasks 123 of server D is updated to zero (FIG. 4).

For each of the tasks (task ID 1 to task ID 6), the data processing section 22 updates the task status 112 representing the status of its execution according to necessity as above.

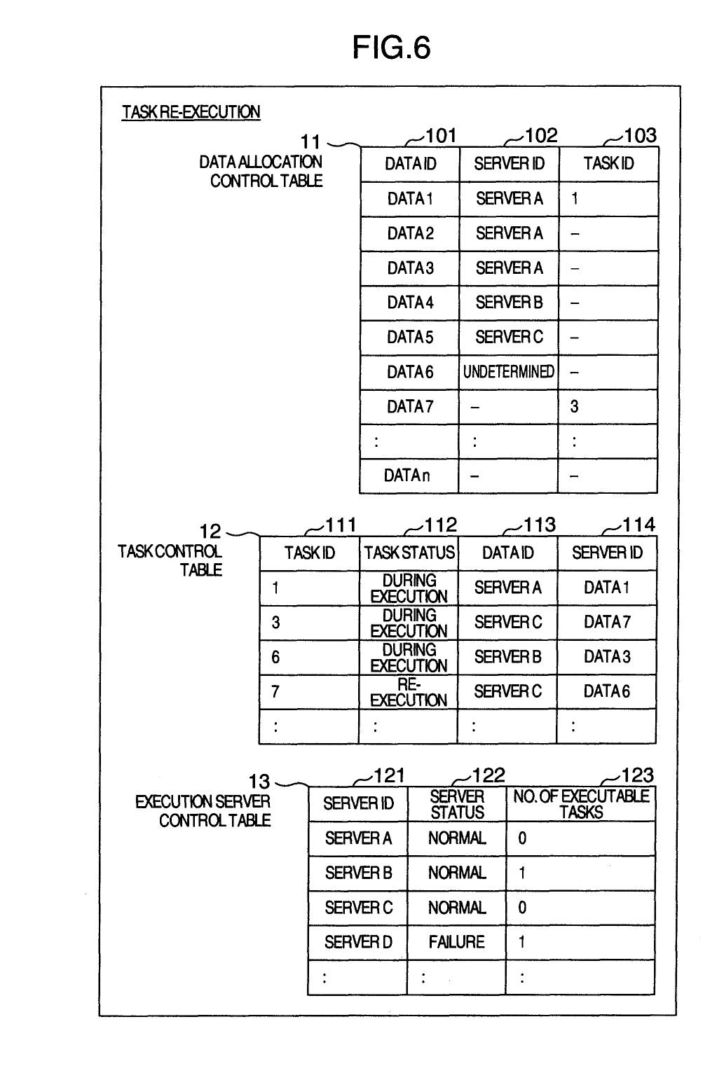

FIG. 6 shows an example of a state of data handled by the schedule server 1 during re-execution of a task. After a lapse of time, the state of FIG. 4 changes to the state of FIG. 6. It is assumed in the state that the execution server 2d (server D) has failed.

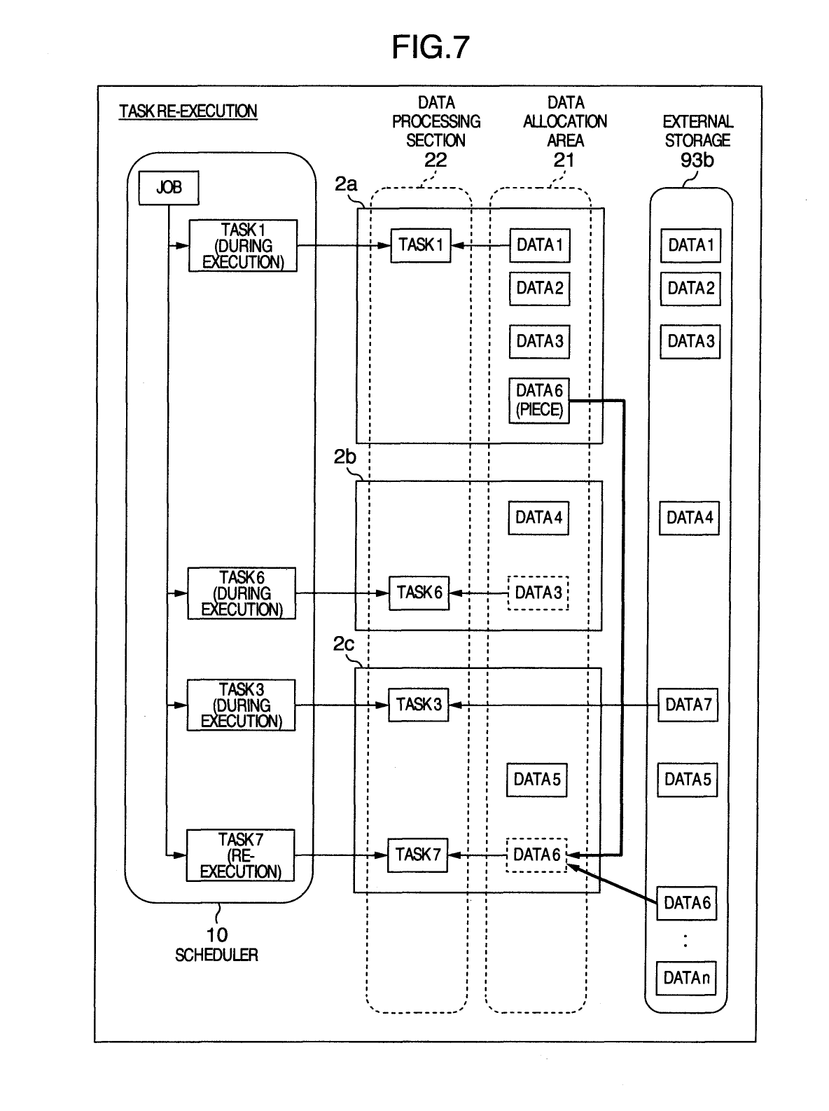

FIG. 7 shows an example of task allocation in the job processing system 8. This state corresponds to the state of task re-execution shown in FIG. 6.

As in FIG. 4, the tasks having a task ID as “1”, “3”, or “6” are being executed.

Since the task for which the task ID is “2”, “4”, or “5” has been interrupted or has been terminated, information thereof is deleted from the data allocation control table 11 and the task control table 12.

The task of “task ID=7” is a task which re-executes the interrupted task of “task ID=5. In allocation of task 7, data 6 which is “(2) Data of failed server” is set as the execution target. A result of the task allocation is written in a record of “task ID 111=task 7”. In the record of “data ID 101=data 4”, the server ID is updated to “indefinite” due to the failure of server D having stored data 6, and the task ID is changed to empty (-).

When “(2) Data of failed server” is employed, the execution server 2c reads, through communication processing, part of data 6 existing in the execution server 2a and reads the remaining part of data 6 from the external storage 93b.

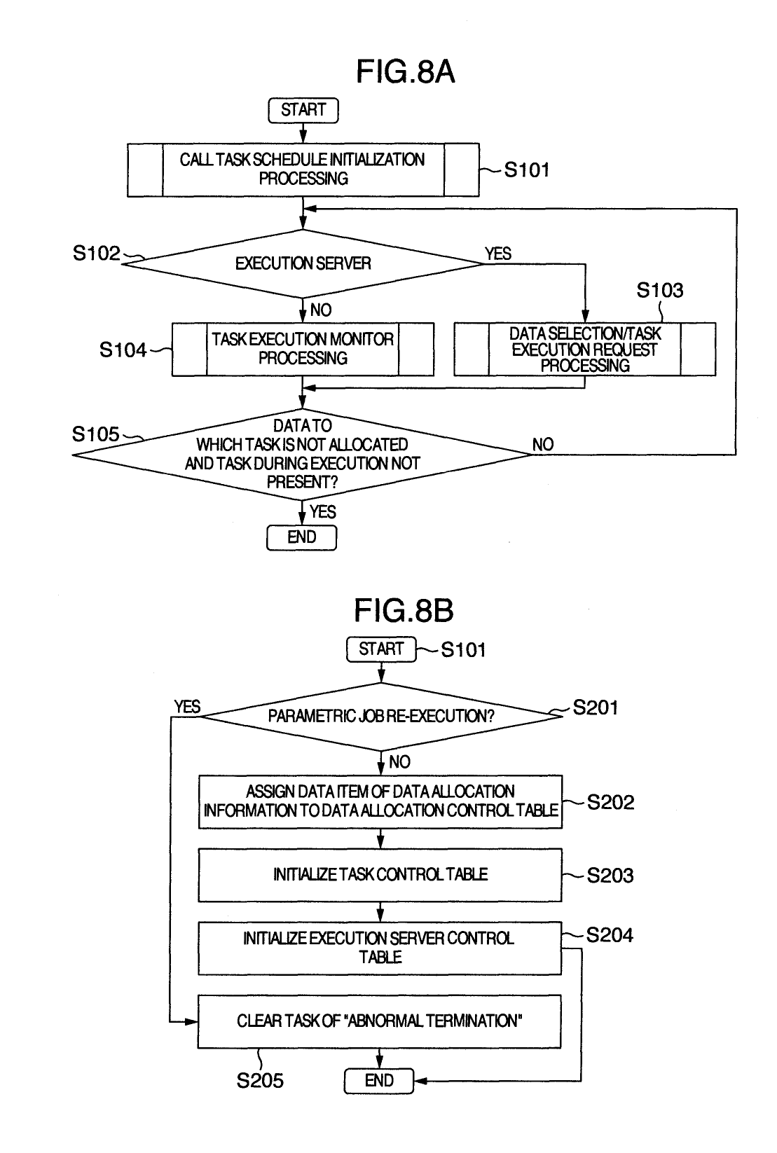

FIG. 8A shows main processing of the scheduling operation to be conducted by the scheduler 10 in a flowchart.

In step S101, the scheduler 10 calls task schedule initialization processing (FIG. 8B).

In step S102, the scheduler 10 searches the execution server control table 13 to retrieve a task allocatable execution server 2 and then makes a check to determine whether or not the execution server 2 has been detected. A task allocatable execution server 2 is an execution server 2 corresponding to a server ID for which the server status is “normal” as well as the number of allocatable execution tasks is one or more in the control table 13. If step S102 results in “yes”, control goes to step S103; otherwise, control goes to step S104.

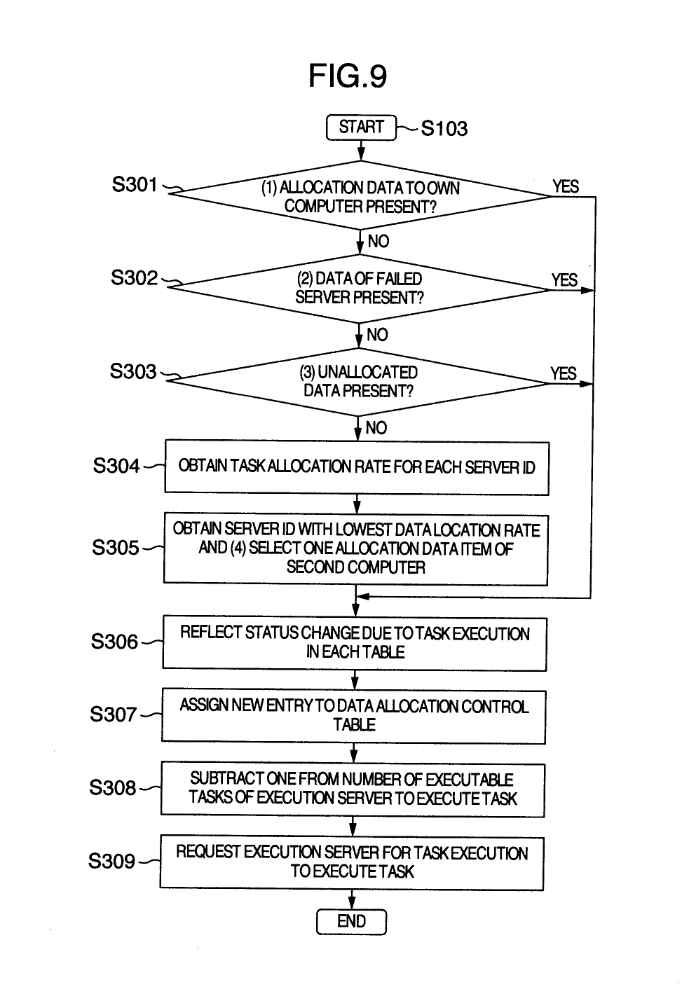

In step S103, the scheduler 10 calls task execution request processing (FIG. 9).

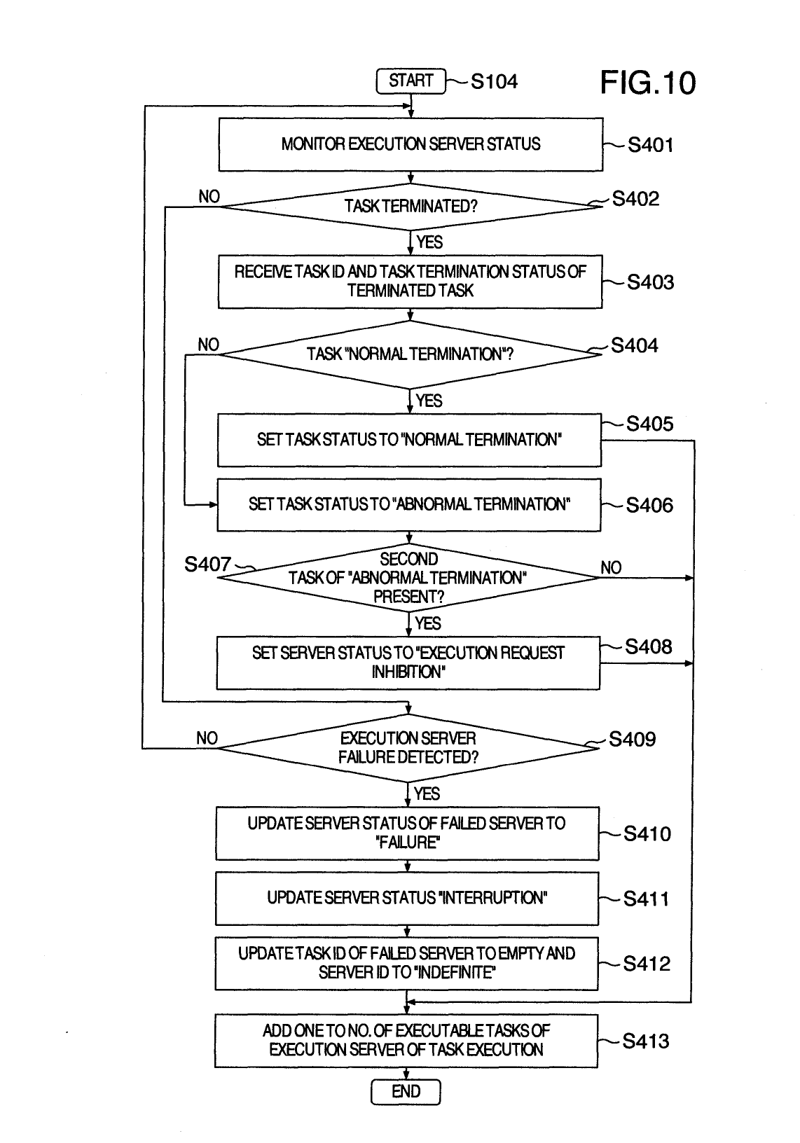

In step S104, the scheduler 10 calls task execution monitor processing (FIG. 10) and then waits for termination of the task for which an execution request has been issued.

In step S105, a check is made to determine whether or not data to which no task has been allocated and a task during execution are present. This is determined based on two conditions, namely, a condition that there exists no entry for which the task ID 111 contains “- (not set)” and a condition that there exists no entry for which the task status 112 is “during execution”. If step S105 results in “yes”, the processing is terminated; otherwise, control goes to step S102.

FIG. 8B shows a flowchart of task schedule initialization processing to be executed by the scheduler 10.

In step S201, a check is made to determine whether or not a parametric job is to be re-executed. If step S201 results in “yes”, control goes to step S205; otherwise, control goes to step S202.

Specifically, if there exists an abnormally terminated task as a result of execution of the parametric job, the scheduler 10 records, in the main storage 92 or the external storage 93a, an information item indicating that the parametric job includes an abnormally terminated task. Presence or absence of the information item is checked at execution of a parametric job later. Or, at execution of a parametric job later, the user designates “re-execution”.

In step S202, the scheduler 10 reads the data allocation information 14, allocates a data allocation control table 11 including entries for the data items designated in the data allocation information 14, and assigns thereto the data ID and the server ID designated in the data allocation information 14.

In step S203, the scheduler 10 initializes a task control table 12.

In step S204, the scheduler 10 initializes an execution server control table 13 to assign entries for each server. The server ID 121 and the number of executable tasks 123 are obtained from, for example, a setting file. The server status 122 is acquired, for example, by issuing a query to the task controller 20 of each execution server 2.

In step S205, to set the data for which the processing is underway by the abnormally terminated task to a processable state, the scheduler 10 attains the task ID 111 for which the task status 112 is “abnormal termination” and clears the task ID 103 matching the task ID 111.

FIG. 9 shows, in a flowchart, data selection and task execution request processing (S103) to be executed by the scheduler 10.

In step S301, (1) the scheduler 10 makes a check to determine whether or not allocation data of its own computer is present. Specifically, the scheduler 10 determines presence or absence of a server ID 102 matching the server ID of the execution server 2 to execute the task. If step S301 results in “yes”, the controller 10 selects data indicated by the data ID 101 of the entry, as data to be processed by the task, and then proceeds to step S306. Otherwise, control goes to step S302.

In step S302, (2) the scheduler 10 judges whether or not data of a failed server is present, that is, whether or not an entry for which the server ID 102 is “indefinite” is present. If step S302 results in “yes”, the controller 10 selects data indicated by the data ID 101 of the entry, as data to be processed by the task, and then proceeds to step S306. Otherwise, control goes to step S303.

In step S303, (3) the scheduler 10 judges whether or not non-allocation data is present, that is, whether or not an entry for which the server ID 102 is empty is present. If step S303 results in “yes”, the controller 10 selects data indicated by the data ID 101 of the entry, as data to be processed by the task, and then proceeds to step S306. Otherwise, control goes to step S304.

In step S304, (4) the scheduler 10 selects allocation data of a second computer. For this purpose, the scheduler 10 classifies the entries of the data allocation control table 11 into task-allocated entries for which the task ID 103 is other than empty and task-non-allocated entries for which the task ID 103 is empty. The scheduler 10 then determines, for each server ID 102, the number of task-allocated entries and that of task-non-allocated entries. For each server ID 102, the scheduler 10 divides the number of the task-allocated entries by the number of all entries to attain a task allocation rate.

In step 305, the scheduler 10 determines a server ID 102 having the smallest task allocation rate and selects, from the entries associated with the server ID 102, data for which the task ID 103 is empty, as allocation data of the second computer.

In step S306, the scheduler 10 reflects state changes caused by the task execution in the respective tables.

First, the scheduler 10 allocates a new entry to the task control table 12 and calculates a value by adding one to the value of the task ID 111 of the previously allocated entry. In the new entry, the scheduler 10 assigns the value to the task ID 111, “during execution” to the task status 112, and the server ID of the execution server 2 to the server ID 113 to execute the task.

Next, the scheduler 100 writes the data ID 102 of the entry of the data allocation table 11 obtained through steps S301 to S305 in the data ID 114 of the new entry.

In step S307, the scheduler 10 assigns the task ID 111 of the new entry of the data allocation control table 11 to the task ID 103, and the server ID of the execution server 2 to execute the task to the server ID 102. This processing is executed because the data allocation state changes when the data is loaded in or transferred to the data allocation area 21. As a result, when a task is abnormally terminated at an intermediate point of the processing and is thereafter re-executed, the execution request is issued to the execution server which has executed the task up to the abnormal termination. Hence, the re-execution is improved in performance.

In step S308, based on the server ID 121, the scheduler 10 detects an entry matching the server ID of the execution server 2 to execute the task in the execution server control table 13 and then subtracts one from the number of executable tasks 123 of the entry.

In step S309, the scheduler 10 transfers the name of the data processing section 22 to be executed by the execution server, the data ID 101 of the entry selected through steps S301 to S305, and the task ID 111 of the entry allocated in step S306 to the task control section 20 of the execution server 2 to execute the task, to thereby issue a task execution request.

FIG. 10 shows the task monitor processing (S104) to be executed by the scheduler 10 in a flowchart.

In step 401, the scheduler 10 monitors the status of the execution server 2, for example, by a health check and waits for a response from the task control section 20 of the execution server 2 as the destination of the task execution request, to thereby monitor the task status.

In step S402, on receiving a response from the task control section 20, the scheduler 10 judges whether or not the task has been terminated. If step S402 results in “yes”, control goes to step S403; otherwise, control goes to step S409.

In step S403, the scheduler 10 receives the task ID and the task termination status of the terminated task.

In step S404, the scheduler 10 judges whether or not the task termination status is “normal termination”. If step S404 results in “yes”, control goes to step S405; otherwise, control goes to step S406.

In step S405, the scheduler 10 detects in the task control table 12 an entry containing a task ID 111 matching the received task ID, updates the task status 112 of the entry to “normal termination”, and then proceeds to step S413.

In step S406, the scheduler 10 updates the task status 112 to “abnormal termination”. If the execution server 2 fails during the execution of the data processing section 22, the scheduler 10 creates a new task and then issues a request, for the processing of the data for which the processing is underway, to an execution server 2 other than the failed execution server 2.

In step S407, the scheduler 10 determines the server ID 113 of the abnormally terminated task in the task control table 12 and determines presence or absence of a second task for which the task status 112 is “abnormal termination” in an entry associated with the server ID 113. If step S407 results in “yes”, control goes to step S408; otherwise, control goes to step S413.

In step S408, the scheduler 10 updates the server status 122 to “execution request inhibition” and proceeds to step S413.

Hence, by removing the execution server 2 from the execution request destinations, execution of a new task in the execution server 2 is prevented. As a result, at abnormal termination, it is possible to save labor and time required to analyze the cause of the abnormal termination.

When a plurality of tasks process mutually different data items under the same application execution conditions such as a condition regarding programs to be executed abnormally terminate in one execution server 2, it is assumed that the cause of the abnormal termination exists in the execution server 2.

In step S409, the scheduler 10 determines whether or not failure of the execution server 2 has been detected. A server in which failure of the execution server 2 has been detected will be referred to as “failed server” hereinbelow.

This is carried out by, for example, a health check in which the scheduler 10, the schedule server 1, or an apparatus connected to the schedule server 1 repeatedly communicates with the execution server 2 to confirm a normal status of the execution server 2. In some cases, to cope with server failure, the data server allocation section 23 keeps a copy of data in one or more servers in a distributive fashion. Hence, the copy allocation place (server) cannot be determined depending on cases. If a data copy exists in a second execution server 2, the data allocation section 23 transfers the data at execution of the data processing section 22. If the step S409 results in “yes”, control goes to step S410; otherwise, control goes to step S401.

In step 410, the scheduler 10 updates the server status 122 of the failed server to “failure”.

In step 411, the scheduler 10 updates the task status 112 of the failed server to “interruption”.

In step 412, the scheduler 10 updates the task ID 103 of the failed server to “empty” and the server ID 102 thereof to “indefinite”. As a result, the data is selected in step S302 to be immediately processed by a second server. That is, the data can be processed without waiting for reactivation of a failure execution server 2 or a backup server.

It is also possible that the scheduler 10 beforehand obtains data redundancy as one setting information item of the data allocation section 23. If the data redundancy is “0”, it is assumed that data is not existing in any other execution server 2. Hence, in step S412, the scheduler 10 clears the server ID 102 without updating it to “indefinite”.

In step S413, the scheduler 10 adds one to the number of executable tasks 123 of the execution server 2 in which the task was being executed (in the current state, the task is interrupted due to a normal termination, an abnormal termination, or server failure).

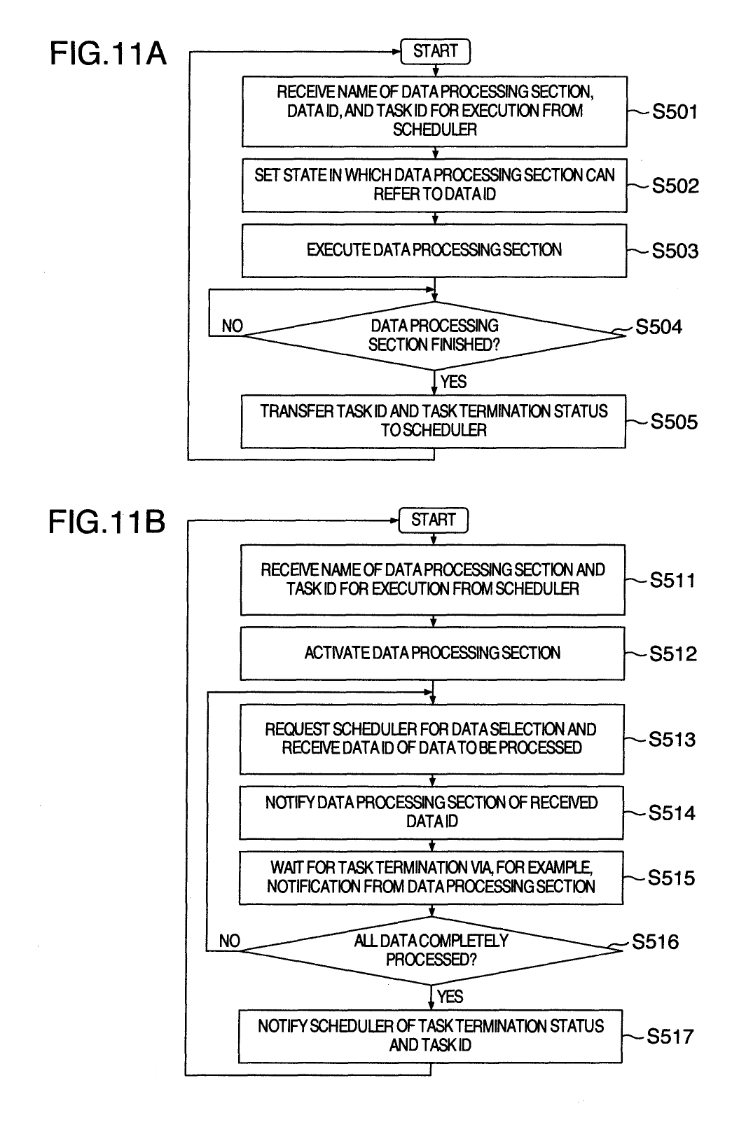

FIG. 11A shows the task execution processing to be executed by the task control section 20 in a flowchart.

In step S501, the task control section 20 receives the name of a data processing section 22 for execution, a data ID, and a task ID from the scheduler 10 of the schedule server 1.

In step S502, the task control section 20 sets the data ID to an environmental variable or an argument of the data processing section 22 to set a state in which the data processing section 22 can refer to the data ID.

In step S503, the task control section 20 executes the data processing section 22.

For example, “task 1” reads “data 1” from the data allocation area 21 for processing thereof.

On the other hand, since “data 7” is not found in “server B”, “task 3” loaded the data from the external storage 93b.

Alternatively, since “data 6” is not existing in “server C”, “task 7” loads the data from “server A” and the external storage 93b.

In step S504, the task control section 20 makes a check to determine whether or not the data processing section 22 has been terminated. The task control section 20 notifies the status (normal or abnormal termination) to the scheduler 10. If step S504 results in “yes”, control goes to step S505; otherwise, control returns to step S504 (namely, the task control section 20 waits for termination of a task executed by the data processing section 22).

In step S505, the task control section 20 transfers the task ID and the task termination status to the scheduler 10.

FIG. 11B is a flowchart of the task execution processing to be executed by the task control section 20. It differs from FIG. 11A in that the data request is issued to the scheduler 10.

In step S511, the task control section 20 receives the name of a data processing section for execution and a task ID from the scheduler 10 of the schedule server 1.

In step S512, the task control section 20 activates the data processing section 22.

Before issuing the task request, the scheduler 10 processes steps S306, S308, and S309. However, in step S306, the scheduler 10 does not assign the data ID.

In step S513, the task control section 20 issues a data selection request to the scheduler 10 and then receives the data ID of data to be processed.

When the data selection request is received from the execution server 2, the scheduler 10 processes steps S301 to S305 and step S307. The scheduler 10 assigns the task ID 103 of the entry of the data allocation control table 11 selected through steps S301 to S305. The scheduler 10 then assigns the data ID 101 of the entry to the data ID 113.

In step 514, the task control section 20 notifies the received data ID to the data processing section 22.

In step 515, the task control section 20 waits for termination of the processing of data indicated by the data ID received by the data processing section 22, for example, via a message from the data processing section 22.

In step 516, the task control section 20 determines, by receiving information indicating absence of the data ID from the scheduler 10, whether or not all data items have been processed or whether or not data is being processed by a second execution server 2. If step S516 results in “yes”, control goes to step S517; otherwise, control goes to step S513.

In step 517, the task control section 20 transfers the task termination status and the task ID to the scheduler 10.

In the embodiment described above, the scheduler 10 refers to data allocation information including a data ID and an ID of a computer having stored associated data and selects data to be allocated to computers of which the number of simultaneously executable tasks is less than the upper-limit value. Specifically, the scheduler 10 selects allocation data of the own computer, data of a failed server, non-allocation data, and allocation data of other computers in this sequence and then transfers data IDs of the data to thereby schedule tasks to process the data.

It is hence possible also in the re-execution to reduce the elongation of the processing time due to occurrence of the data transfer wait and/or the input/output wait.

It should be further understood by those skilled in the art that although the foregoing description has been made on embodiments of the invention, the invention is not limited thereto and various changes and modifications may be made without departing from the spirit of the invention and the scope of the appended claims.

1. A job processing method for use with a job processing system comprising execution servers to execute tasks of a parametric job and a schedule server which extracts each of the tasks from the parametric job and which requests associated one of the execution servers to execute the task, wherein:
the schedule server comprises a scheduler and a data allocation control table;
each of the execution servers comprises a data allocation area, a data processing section, a data allocation section, and an external storage;
the data allocation section reads a data set as a processing target of the task in the data allocation area of an own execution server, and notifies correspondence information between the data set and the own execution server;
the scheduler stores, in the data allocation control table, the notified correspondence information between the data set and the own execution server to which information of a task executing the data set as a processing target is further added;
the scheduler retrieves, when selecting the execution server which can execute the task as the allocation-target execution server as an allocation target and allocating the task thereto, the data set as the processing target of the new task from the data allocation control table;
for data obtaining target at execution of the allocation-target execution server in the data processing section, if the data set as the processing target is beforehand allocated to the data allocation area in the allocation-target execution server, the scheduler sets the data set as the data obtaining target; and
if the data set as the processing target is beforehand allocated to the data allocation area in a second execution server other than the allocation-target execution server, the scheduler sets the data set allocated to the second execution server as the data obtaining target.

2. A job processing method according to claim 1, wherein if the data set as the processing target is beforehand allocated to the data allocation area in each of a plurality of the execution servers as allocation targets, the scheduler selects the data set of any ones of the execution servers in which failure has not occurred as the data obtaining target in preference to the data set of the execution servers in which failure has occurred.

3. A job processing method according to claim 1, wherein if the data set as the processing target is beforehand allocated to the data allocation area in each of a plurality of the execution servers other than the execution server as an allocation target, the scheduler sets as the data obtaining target the data allocation area in one of the execution servers having a lowest task allocation rate.

4. A job processing method according to claim 1, wherein:
the data processing section detects abnormal termination of a task during execution and notifies the abnormal termination to the scheduler; and
when abnormal termination of a plurality of tasks is notified from the data processing section in a predetermined one of the execution servers, the scheduler excludes the predetermined execution server from the execution servers as allocation targets at allocation of a new task.

5. A job processing method according to claim 1, wherein:
the data processing section detects abnormal termination of a task during execution and notifies the abnormal termination to the scheduler; and
when abnormal termination of a plurality of tasks is notified from the data processing section in a predetermined one the execution servers, the scheduler searches an entry of the task associated with the notification of abnormal termination from tasks indicated as “during execution” in the data allocation control table and then clears the tasks of “during execution” from the entry.

6. A job processing method according to claim 1, wherein if the data set as the processing target is not beforehand allocated to the data allocation area in any one of the execution servers, the scheduler sets the data allocation area in the external storage as the data obtaining target.

7. A job processing method for use with a job processing system comprising execution servers to execute tasks of a parametric job and a schedule server which extracts each of the tasks from the parametric job and which requests associated one of the execution servers to execute the task, wherein:
the schedule server comprises a scheduler and a data allocation control table;
each of the execution servers comprises a data allocation area, a data processing section, a data allocation section, and an external storage;
the data allocation section reads a data set as a processing target of the task in the data allocation area of an own execution server, and notifies correspondence information between the data set and the own execution server;
the scheduler stores, in the data allocation control table, the notified correspondence information between the data set and the own execution server to which information of a task executing the data set as a processing target is further added;
the scheduler retrieves, when selecting the execution server which can execute the task as the allocation-target execution server as an allocation target and allocating the task thereto, the data set as the processing target of the new task from the data allocation control table;
for data obtaining target at execution of the allocation-target execution server in the data processing section, if the data set as the processing target is beforehand allocated to the data allocation area in the allocation-target execution server, the scheduler sets the data set as the data obtaining target;
if the data set as the processing target is not beforehand allocated to the data allocation area in any one of the execution servers, the scheduler sets the data set in the external storage area as the data obtaining target; and
if the data set as the processing target is beforehand allocated to the data allocation area in a second execution server other than the allocation-target execution server, the scheduler sets the data set allocated to the second execution server as the data obtaining target.
